(19) United States
(12) Patent Application Publication
(10) Pub. No.: US 2005/0029461 A1
(43) Pub. Date: Feb. 10, 2005

(54) Gamma camera using rotating scintillation bar detector and method for tomographic imaging using the same

(75) Inventor: Ronald E. Malmin, Chicago, IL (US)

Correspondence Address: Elsa Keller;Intellectual Property Department, Siemens Corporation, 170 Wood Avenue South, Iselin, NJ, 08830, US

(73) Assignee: Siemens Medical Solutions USA, Inc.

(21) Appl. No.: 10/633,935

(22) Filed: Aug. 4, 2003

(51) Int. Cl. G01T 1/20

(52) U.S. Cl. 250/367

(57) ABSTRACT

A gamma camera includes a number of bar detector strips made of scintillating material, arranged in a stack configuration, where at least one photodetector is coupled to one or both ends of each detector strip, and a slat collimator including a plurality of elongated slats, for collimating each of the bar detector strips to receive gamma photons in only a single dimension. According to another aspect of the invention, a method of obtaining tomographic images of an object includes the steps of obtaining a number of sets of planar integral scintillation event data from the object at a number of azimuth angles of a rotating scintillation detector for each of a number of gantry angles of a gamma camera, and reconstructing the sets of planar integral scintillation event data to form a tomographic image of the object.

### BACKGROUND OF THE INVENTION

1. Field of the Invention

The present invention generally relates to nuclear medicine, and systems for obtaining nuclear medicine images of a patient's body organs of interest. In particular, the present invention relates to a novel detector configuration for nuclear medical imaging systems that are capable of performing single photon emission computed tomography (SPECT) to obtain tomographic images.

2. Description of the Background Art

Nuclear medicine is a unique medical specialty wherein radiation is used to acquire images that show the function and anatomy of organs, bones or tissues of the body. Radiopharmaceuticals are introduced into the body, either by injection or ingestion, and are attracted to specific organs, bones or tissues of interest. Such radiopharmaceuticals produce gamma photon emissions that emanate from the body. One or more detectors are used to detect the emitted gamma photons, and the information collected from the detector(s) is processed to calculate the position of origin of the emitted photon from the source (i.e., the body organ or tissue under study). The accumulation of a large number of emitted gamma positions allows an image of the organ or tissue under study to be displayed.

Single photon imaging, also known as planar or SPECT imaging, relies on the use of a collimator placed in front of a scintillation crystal or solid state detector, to allow only gamma rays aligned with the holes of the collimator to pass through to the detector, thus inferring the line on which the gamma emission is assumed to have occurred. Conventional single photon imaging techniques require gamma ray detectors that calculate and store both the two-dimensional position of the detected gamma ray (in x, y coordinate form) and its energy (typically in keV).

Present day single photon imaging systems all use large area scintillation detectors (on the order of 2000 cm²). Such detectors are made either of sodium iodide crystals doped with thallium (NaI(Tl)), or cesium iodide (CsI). Scintillations within the NaI crystal caused by absorption of a gamma photon within the crystal, result in the emission of a number of light photons from the crystal. The scintillations are detected by an array of photomultiplier tubes (PMTs) in close optical coupling to the crystal surface. Energy information is obtained by summing the signals from the PMTs that detected scintillation photons, and position information is obtained by applying a positioning algorithm to the quantitative signals produced by the PMT array. The original gamma-ray camera is described in U.S. Pat. No. 3,011,057 issued to Hal Anger in 1961.

Because the conventional Anger camera uses a thin planar sheet or disk of scintillation crystal material, it is necessary to cover the entire field of view of the crystal with light detectors such as PMTs or photodiodes. PMTs do not contribute to high spatial resolution because of their large physical size (˜76 mm) and the uncertainty in PMT output signals as a function of scintillation event position. The signal from a PMT as a function of position forms a bell-shaped curve (Light Response Function or LRF) whose slope (or lack thereof) introduces uncertainty as to the position of the scintillation event that produced it. Complex position calculating electronics thus are usually required to be used with PMT detectors.

Current design Anger cameras are sub-optimal for higher energy gamma ray imaging. Increasing crystal thickness to absorb more photons leads to a broader LRF and degraded position resolution. In addition, standard collimators for high energy photons require larger holes and thicker septa leading to degraded resolution and “septal” artifacts in the image.

The CsI camera is typically a pixellated system with each pixel/crystal coupled to a single silicon-based photodiode detector or an array of silicon-based photodiode detectors. CsI crystals are used where the relatively low cost, ruggedness and spectral response of the CsI crystal are desired in favor of alternative crystal materials such as NaI. The CsI camera still requires complex positioning electronics in that each pixel requires a separate electronic processing and readout circuit.

The bar detector is a specific configuration of scintillation detector that has been used in astronomical and high energy physics applications. The bar detector consists of an elongated scintillation crystal bar having a relatively small cross section. A photosensor such as a PMT is optically coupled to each end of the bar. The light from a gamma photon event within the scintillation crystal volume is detected by the two PMTs. The relative amount of light collected at each of the two ends can be used to determine the location of the event in the bar. Additional bars can be placed next to each other for two dimensional detection.

A so-called rotating slit gamma camera is also known in the art, see, e.g., U.S. Pat. No. 4,514,632 to Barrett, issued Apr. 30, 1985. The rotating slit camera has an elongated slit provided in an opaque disk located between the imaging object and the detector, such that scintillation event detection is obtained only in one dimension along the length of the slit (i.e., only a single spatial coordinate is obtained) at a time. The disk is rotated with respect to the detector to obtain spatial position information along other directions. One advantage of the rotating slit camera is that it eliminates the requirement for the inefficient simple collimator or pinhole apertures in the conventional Anger camera, which greatly restrict the percentage of gamma photons emanating from an imaging object that ultimately reach the detector.

There is thus an existing need in the art to provide a new type of tomographic camera that eliminates the need for expensive and complex position calculating electronics, while providing high position resolution at low or high gamma energies and improving reliability over conventional PMT-based cameras, and decreasing cost.

### SUMMARY OF THE INVENTION

The present invention solves the existing need by providing a gamma camera having a scintillation detector formed of a stack of scintillation bar detectors with slat collimation. Scintillation photons are detected from the ends of the bars by a pair of light-sensitive detectors.

According to one aspect of the invention, a gamma camera includes a number of bar detector strips made of scintillating material, arranged in a stack configuration, where at least one photodetector is coupled to at least one end of the stack, and a slat collimator including a plurality of elongated slats, for collimating each of the bar detector strips to receive gamma photons in only a single dimension.

According to another aspect of the invention, a method of obtaining tomographic images of an object includes the steps of obtaining a number of sets of planar integral scintillation event data from the object at a number of azimuth angles of a rotating scintillation detector for each of a number of gantry angles of a gamma camera, and reconstructing the sets of planar integral scintillation event data to form a tomographic image of the object.

### BRIEF DESCRIPTION OF THE DRAWINGS

The invention will become more clearly understood from the following detailed description in connection with the accompanying drawings, in which:

FIGS. 1a and 1b are isometric views of a rotating bar detector gamma camera with slat collimation, according to two alternate embodiments of the present invention;

FIG. 2 is an end plan view of the rotating bar detector gamma camera of FIGS. 1a and 1b; and

FIG. 3 is a diagram illustrating the use of the rotating bar detector camera according to the invention, to obtain tomographic images of a subject.

### DETAILED DESCRIPTION OF THE PREFERRED EMBODIMENTS

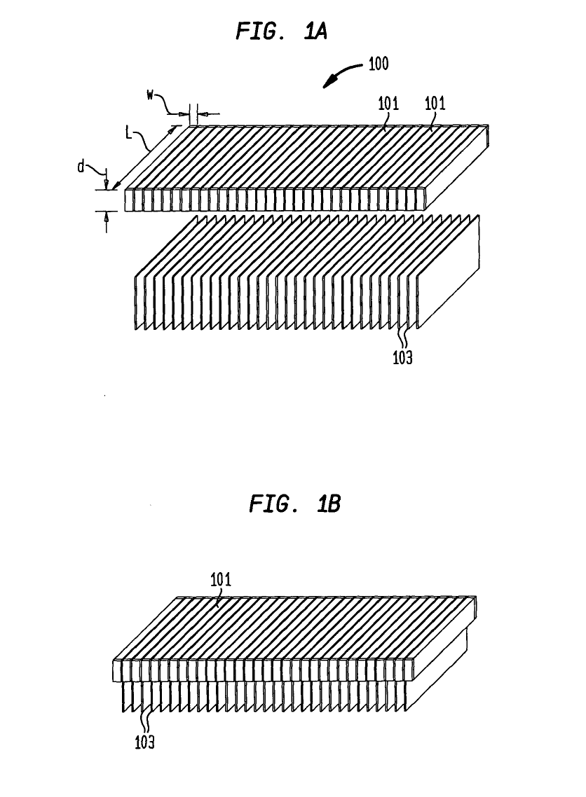

Referring to FIGS. 1a and 1b, according to one preferred embodiment of the invention, a gamma camera detector 100 is provided, which is constructed of a stack of scintillation bars 101. In the preferred embodiment, each scintillation bar 101 is a narrow strip of CsI, however other scintillator materials can be used, such as NaI, LSO, LaBr3, LaCl3, etc.

Each bar 101 is collimated by a “slat” collimator 103, which collimates gamma photons in one dimension only (i.e., along the length of the bar), similar to the rotating slit camera as disclosed in the above-mentioned '632 patent. Unlike the present invention, however, the '632 patent utilizes a conventional thin planar sheet of scintillation crystal material.

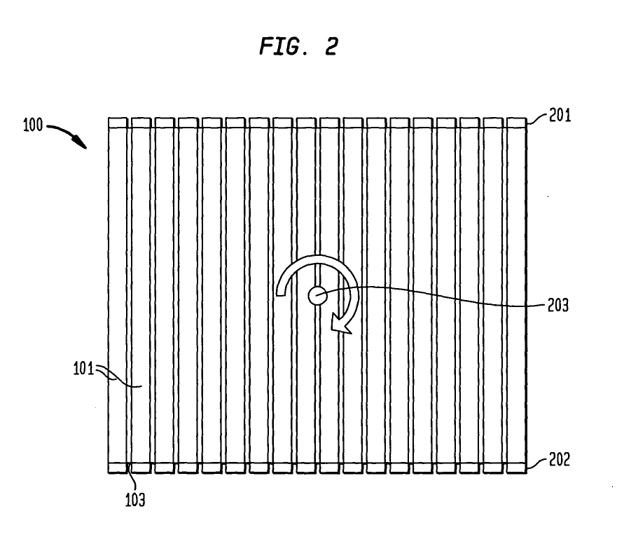

Light photons generated by absorption of gamma rays within the bars 101 are collected at the ends of each bar by a pair of photodetectors 201, 202 (as shown in FIG. 2). In the preferred embodiment, silicon drift detectors (SDDs) are used as the light photon detectors 201, 202; other types of photodetectors also may be used in accordance with the invention, such as small area photodiodes or photodiode arrays, position-sensitive PMTs (PS-PMTs), or other solid-state photodetectors.

As shown in FIGS. 1a-1b, the detector 100 is composed of a stack of narrow bar detector strips, each having the same length L, width w, and depth d. As illustrated, the width dimension w is significantly smaller than the depth d. The bar strips are each collimated by slat collimators 103. As shown, the slat 103 length and spacing matches the length and width of the bars 101. The entire slat collimator may be placed in front of the bar detector stack with respect to an imaging object (FIG. 1a), or the individual bars 101 may be located between slats 103 (FIG. 1b).

When placed adjacent to an imaging object that is emitting gamma radiation, each collimated bar will absorb gamma photons from a plane within the object. Gamma absorptions within each narrow strip produce a number of light photons that travel along the length of the bar strip in each direction, and are collected at the ends of the bar strip by the pair of SDDs 201, 202. As explained above, because the slat collimators collimate gamma photons in only one dimension (along their length), high position resolution is required in only the dimension perpendicular to the collimated bars. Consequently, a desirable value for the width w of the bar detector strips for contemplated medical imaging applications is on the order of 3 mm.

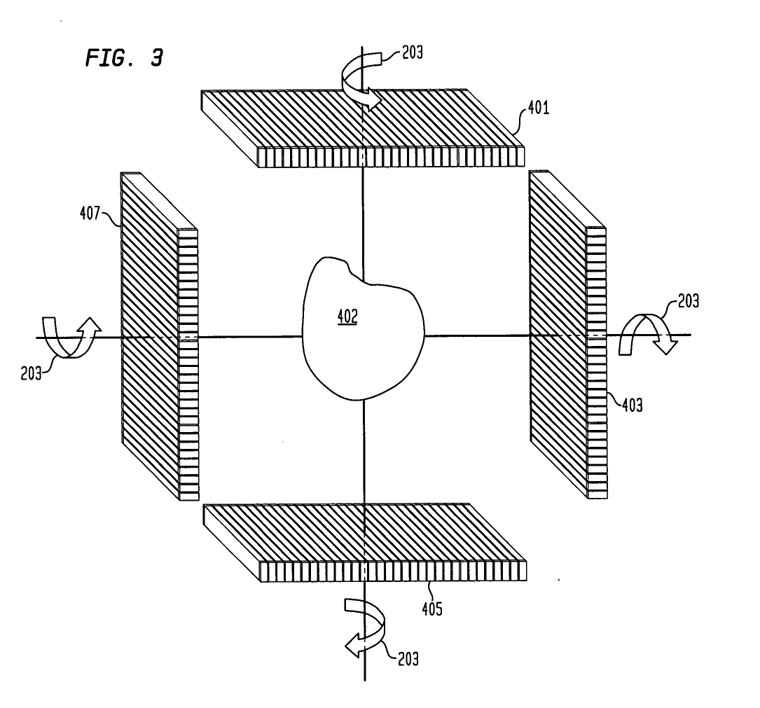

Because the slat collimators collimate gamma photons in only one dimension, the stack of bar detectors collects a set of planar integrals at each rotational position, as opposed to the line integrals that are collected by the conventional PMT arrays of the conventional Anger gamma camera. The bar detector stack 100 is positioned at a fixed gantry angle, and collects a sufficient number of events at its initial azimuthal position. The bar detector stack 100 then is rotated azimuthally about its central normal axis 203 as shown in FIG. 2. The bar detectors may be rotated through a total rotation angle of 180 degrees in increments, such as 3-5 degree rotational increments. The bar detectors then collect additional sets of planar events at each of the rotation angle increments. As shown in FIG. 3, the process is repeated at a number of different gantry angles 401, 403, 405, and 407 with respect to an imaging object 402 such as a patient undergoing medical imaging. The resulting sets of planar integrals can be reconstructed to form a full tomographic image of the object 402.

Use of the stack of bar detector strips 100 in a rotating slat collimator configuration exhibits several desirable characteristics. As explained above, because of the one-dimensional nature of the detection, high positional resolution is required only in the dimension perpendicular to the slat collimators, and thus a narrow width bar detector strip on the order of 3 mm may be used, with light photon collection at each end. Position information along the bar is not required. Because light produced by scintillation events in each bar is channeled within the small area of each bar, extremely high count rates are possible without pileup from spatially separated events, especially if each bar detector is provided with its own detector readout electronics (in the case of PS-PMTs, each PS-PMT would detect light from multiple bars, with a corresponding reduction in the maximum count rate).

The reduction in pileup in turn allows the use of slower scintillator materials, such as CsI, which are well-matched to compact photodetectors such as photodiodes and SDDs. Because it is not necessary to determine spatial positioning of individual events along the length of the scintillation bars for image construction, no positioning calculations are required for imaging. Simple, fast positioning algorithms utilizing light collection ratios between the pair of photodetectors 201, 202 allow sufficient spatial resolution along the length of the bar to be utilized for the purpose of performing energy correction (e.g., energy correction based on spatial position of the event) to improve system energy resolution.

The use of SDDs as photodetectors coupled to CsI bar detector strips is of particular interest, in that SDDs may be grown to match the cross-section of the bars (either as single photodetectors or as arrays), and SDDs are very low noise devices. Each pair of SDDs collects the total light produced by each gamma event, thus providing a large signal-to-noise ratio. However, as mentioned above, arrays of smaller area photodiodes coupled to the bar detectors, or position-sensitive PMTs, are other possibilities for implementation of the photodetectors.

Because the depth of the bar detector does not affect spatial resolution, high spatial resolution is possible at high gamma ray energies, and the septa (slat collimators) can be made thick without causing septal artifacts in the resulting images.

The rotating bar detector gamma camera according to the present invention provides a number of advantages in the art, including: relatively low overall cost; elimination of drift-prone PMTs and associated complex position calculation electronics; use of reliable solid-state silicon detectors; complete elimination of the need for positioning electronics, or alternatively use of very simple position readout electronics for energy correction; a compact, flat detector profile, and high position resolution at all energy levels.

Although the preferred embodiment of the invention includes photodetectors at each end of each scintillation bar, an alternative embodiment of the rotating bar detector would collect light at only one end of the bar, with an optimal surface treatment at the other end of the bar, such as a reflector, a diffuse surface treatment, or other surface treatment that optimizes light collection by the photodetector. This would reduce electronics complexity and cost to a bare minimum, but with the tradeoff of degraded energy resolution as less light would be collected for each event, as no energy correction based on event spatial location would be possible. The invention having been described, it will be apparent to those skilled in the art that the same may be varied in many ways without departing from the spirit and scope of the invention. Any and all such modifications are intended to be included within the scope of the following claims. For example, while the invention has been described with respect to a nuclear medicine application, the novel imaging camera may have applications in other areas, such as scanning very large volumes with minimal crystal material—e.g., scanning cargo containers for radioactive material or for explosives using the (n,γ) reaction which causes nitrogen rich material to emit high energy gammas.

1. A gamma camera, comprising:
a plurality of bar detector strips made of scintillating material, arranged in a stack configuration;
at least one photodetector coupled to at least one end of said stack; and
a slat collimator including a plurality of elongated slats, for collimating each of said plurality of bar detector strips to receive gamma photons in only a single dimension.

2. A gamma camera as set forth in claim 1, further comprising a plurality of photodetectors each coupled to at least one end of each bar detector strip of said stack.

3. A gamma camera as set forth in claim 2, wherein said pair of photodetectors are silicon drift detectors (SDDs).

4. A gamma camera as set forth in claim 2, wherein said photodetectors are photodiodes.

5. A gamma camera as set forth in claim 1, wherein said bar detector strips are formed of CsI.

6. A gamma camera as set forth in claim 1, wherein said photodetector is a position-sensitive photomultiplier tube (PS-PMT).

7. A gamma camera as set forth in claim 1, wherein each bar detector strip is located between individual slats of said slat collimator.

8. A gamma camera according to claim 7, wherein each of said individual slats has a length matching the length of said bar detector strips.

9. A gamma camera as set forth in claim 1, wherein said slat collimator is mounted adjacent to said stack.

10. A gamma camera according to claim 9, wherein each of said individual slats has a length matching the length of said bar detector strips in said stack, and wherein spacing between slats of said slat collimator matches dimensions of said bar detector strips.

11. A gamma camera, comprising:
a plurality of bar detector strips made of scintillating material;
at least one photodetector coupled to an end of each of said bar detector strips; and
a slat collimator including a plurality of elongated slats, for collimating each of said plurality of bar detector strips to receive gamma photons in only a single dimension.

12. A gamma camera as set forth in claim 11, wherein said photodetectors are silicon drift detectors (SDDs).

13. A gamma camera as set forth in claim 11, wherein said photodetectors are photodiodes.

14. A gamma camera as set forth in claim 11, wherein said bar detector strips are formed of CsI.

15. A gamma camera as set forth in claim 11, wherein each bar detector strip is located between individual slats of said slat collimator.

16. (Cancelled)

17. (Cancelled)

18. A gamma camera according to claim 15, wherein each of said individual slats has a length matching the length of said bar detector strips.

19. A method of obtaining tomographic images of an object, comprising the steps of:
obtaining a plurality of sets of planar integral scintillation event data from said object at a plurality of azimuth angles of a rotating scintillation bar detector for each of a plurality of gantry angles of a gamma camera, said scintillation bar detector including
a plurality of bar detector strips made of scintillating material;
at least one photodetector coupled to an end of each of said bar detector strips; and
a slat collimator including a plurality of elongated slats, for collimating each of said plurality of bar detector strips to receive gamma photons in only a single dimension; and
reconstructing said plurality of sets of planar integral scintillation event data to form a tomographic image of said object.

20. A method of obtaining tomographic images of an object, comprising the steps of:
obtaining a plurality of sets of planar integral scintillation event data from said object at a plurality of azimuth angles of a rotating scintillation detector for each of a plurality of gantry angles of a gamma camera; and
reconstructing said plurality of sets of planar integral scintillation event data to form a tomographic image of said object.

21. A gamma camera according to claim 1, further comprising at least a second photodetector coupled to a second end of said stack.

22. A gamma camera according to claim 2, wherein photodetectors are coupled to both ends of each bar detector strip of said stack.

23. A gamma camera as set forth in claim 11, wherein said slat collimator is mounted adjacent to said plurality of bar detector strips.

24. A gamma camera according to claim 23, wherein each of said elongated slats has a length matching the length of said bar detector strips, and wherein spacing between slats of said slat collimator matches dimensions of said bar detector strips.

25. A gamma camera according to claim 11, wherein photodetectors are coupled to both ends of each bar detector strip of said stack.
